(19) United States
(12) Patent Application Publication
(10) Pub. No.: US 2021/0081840 A1
(43) Pub. Date: Mar. 18, 2021

(54) USING A MACHINE LEARNING MODEL TO DETERMINE ACCEPTABILITY OF REMEDIAL ACTIONS FOR SUPPLY PLAN DEVIATIONS

(71) Applicant: Oracle International Corporation, Redwood Shores, CA (US)

(72) Inventors: Jennifer Darmour, Seattle, WA (US); Loretta Marie Grande, Seattle, WA (US); Ronald Paul Lapurga Viernes, Seattle, WA (US); Jingyi Han, San Jose, CA (US); Nicole Santina Giovanetti, Rancho Cordova, CA (US); Jason Wong, Seattle, WA (US); Min Hye Kim, Newcastle, WA (US)

(73) Assignee: Oracle International Corporation, Redwood Shores, CA (US)

(21) Appl. No.: 17/016,063

(22) Filed: Sep. 9, 2020

Related U.S. Application Data
(60) Provisional application No. 62/900,493, filed on Sep. 14, 2019.

(51) Int. Cl. G06N 20/00; G06K 9/62; G06Q 10/08

(52) U.S. Cl. CPC G06N 20/00; G06Q 10/083; G06K 9/6215; G06K 9/6256

(57) ABSTRACT

A system for analyzing supplier communications regarding deviations from a supply plan is described. The system may determine the severity of the deviation and determine an impact to a supply chain or inventory level caused by the deviation. A remedial action may be identified in supplier communications and the system may determine whether the remedial action is acceptable for addressing the deviation. Analyses of supply plan deviations, the severity of deviations, the acceptability of remedial actions, and/or other factors may be used to generate a supplier score.

### INCORPORATION BY REFERENCE; DISCLAIMER

This application is hereby incorporated by reference: application no. 62/900,493 filed on Sep. 14, 2019. The Applicant hereby rescinds any disclaimer of claim scope in the parent application or the prosecution history thereof and advises the USPTO that the claims in this application may be broader than any claim in the parent application.

### TECHNICAL FIELD

The present disclosure relates to analyzing communications related to supply plan deviations. In particular, the present disclosure relates to using a machine learning model to determine whether a remedial action is an acceptable remedy to a supply chain deviation.

### BACKGROUND

Communications may be transmitted over a variety of communication channels between different entities. Examples of communication channels include email, instant messaging, social media platforms, project collaboration applications, gaming applications, electronic photo albums, and dedicated supply chain applications that facilitate purchase order transmittal, order fulfillment, and financial transactions. The term “entity” as used herein may refer to a company or organization (such as a supplier company or a customer company), and/or a person.

In some cases, an entity has multiple options for entities with whom to converse about a particular topic. As an example, a customer may have multiple suppliers from which the customer may purchase a desired product or service. As another example, a procurement officer of a company may have multiple sales representatives with whom the procurement officer may discuss a product issue. As another example, a social media user may have the option of approaching multiple other users for advice and/or recommendations.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example system including a trained machine learning model that may analyze supplier communications to generate a supplier score and/or determine whether a remedial action proposed by a supplier in response to a supply plan deviation meets an acceptance criteria, in accordance with one or more embodiments;

FIG. 2 illustrates an example set of operations for training a machine learning model to analyze communications related to supply plans, in accordance with one or more embodiments;

FIG. 3A illustrates an example set of operations for identifying a supply plan deviation and generating a supplier score based on an analysis of supplier communications, in accordance with one or more embodiments;

FIG. 3B illustrates an example set of operations for determining deviation attributes, in accordance with one or more embodiments;

FIG. 4A illustrates an example set of operations for determining whether a remedial action meets an acceptance criteria, in accordance with one or more embodiments;

FIG. 4B illustrates an example set of operations for training a machine learning model to determine acceptance criteria for a remedial action used in response to a supply plan deviation, in accordance with one or more embodiments;

FIG. 5 illustrates an example user interface for presenting a supplier score and a reply recommendation based on one or more message ratings, in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

1. GENERAL OVERVIEW

2. SYSTEM ARCHITECTURE
2.1 TERMINOLOGY
2.2 SUPPLY NOTIFICATION ANALYSIS SYSTEM ARCHITECTURE

3. SUPPLY PLAN DEVIATION ANALYSIS TECHNIQUES
3.1 MACHINE LEARNING ENGINE TRAINING
3.2 SUPPLY PLAN DEVIATION ANALYSIS

4. DETERMINING ACCEPTABILITY OF REMEDIAL ACTIONS

5. EXAMPLE EMBODIMENT

6. COMPUTER NETWORKS AND CLOUD NETWORKS

7. HARDWARE OVERVIEW

8. MISCELLANEOUS; EXTENSIONS

### 1. General Overview

One or more embodiments described herein include analyzing supplier communications regarding deviations from a supply plan. Some embodiments may determine the severity of the deviation. For example, some embodiments may determine an impact to a supply chain, inventory level, or production operations caused by the deviation. Some embodiments may further analyze the supplier communications to identify a remedial action submitted by the supplier to address the deviation from the supply plan and further determine whether the remedial action is acceptable. Some embodiments may use analyses of supply deviations, the severity of deviations, the acceptability of remedial actions, and/or other factors to generate a supplier score. This score may, in some cases, be generated relative to similar analyses conducted for other suppliers or normalized based on any number of related factors to improve the basis for comparing scores.

A machine learning model classifies one or more attributes corresponding to a supply plan deviation and/or a remedial action. These attributes may be identified in communications to or from a supplier. The communication may notify a purchaser or recipient (equivalently referred to herein as “an entity”) of a deviation and/or remedial action or confirm the presence of a deviation and/or implementation of a remedial action proposed by either a supplier or an entity. Attributes may be used to determine a severity level of a deviation.

Example attributes include, but are not limited to, a type of impact associated with a deviation, a frequency of deviations, of all types, associated with a supplier, a frequency of deviations of a same type associated with a supplier or a particular product. The machine learning model may be trained based on set(s) of communications from one or more suppliers that communicate supply plan deviations and/or remedial actions. For supervised machine learning models, associations between attributes and deviation types, and degrees of acceptability of remedial actions may be provided to the machine learning model by senior supply chain staff having extensive related experience.

Along with machine learning, embodiments described herein may analyze supplier notifications using natural language processing (NLP), keyword analysis, and/or sentiment analysis to detect a sentiment associated with a message. NLP may be used (for example, in combination with machine learning techniques) to determine attributes of supplier notifications, and the relationship between a notification of a deviation and a corresponding notification of a remedial action. For example, the system may use NLP techniques to identify that a notification from a supplier indicates a delayed shipment and a remedial action of a price discount. The trained machine learning model may associate the NLP identified information with attributes and further identify that a price discount does not adequately remedy a supply disruption. This analysis may be used to generate a low value of an acceptability score for the remedial action. This information may also be used to generate a supplier score. Supplier scores may be generated for multiple suppliers and compared to one another to differentiate performance of different suppliers. Systems described herein may compare supplier scores relative to one or more thresholds to grade supplier performance. In some embodiments, the scores may be limited to different suppliers of a same product, thereby further improving the relevance of the comparison of different suppliers.

One or more embodiments described in this Specification and/or recited in the claims may not be included in this General Overview section.

### 2. System Architecture

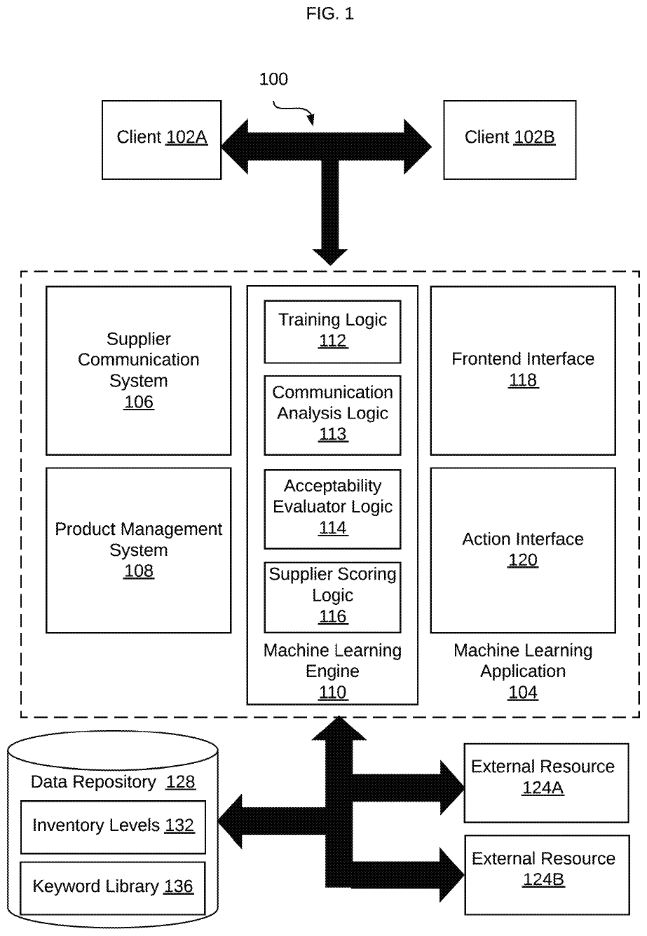

FIG. 1 illustrates an example system architecture of a system 100 configured for analyzing supplier communications, identifying deviations from a supply plan and remedial actions, determining whether the remedial actions are acceptable, and generating acceptability scores and supplier scores.

Before describing the example system 100 in detail, an explanation of various terms follows.

### 2.1 Terminology

In one or more embodiments, a communication channel refers to a method or manner in which a message is transmitted between users. Examples of communication channels include email, instant messaging, social media platforms, project collaboration applications, gaming applications, electronic photo albums, and dedicated supply chain applications that facilitate purchase order transmittal, order fulfillment, and financial transactions. A correspondence chain, or communication chain, may include one or more messages transmitted between two or more users. These users may be associated with a purchasing entity (“entity”) and a supplier to the entity.

In one or more embodiments, information obtained from one or more communication channels (such as messages) may be stored in one or more data repositories. A data repository is any type of storage unit and/or device (e.g., a file system, database, collection of tables, or any other storage mechanism) for storing data. Further, a data repository may include multiple different storage units and/or devices. The multiple different storage units and/or devices may or may not be of the same type or located at the same physical site. Further, a data repository may be implemented or executed on the same computing system as a supply plan deviation system. Alternatively or additionally, a data repository may be implemented or executed on a computing system separate from a supply plan deviation system. The data repository may be communicatively coupled to the supply plan deviation system via a direct connection or via a network.

In one or more embodiments a supply plan may correspond to an agreement by a supplier to supply one or more products under a set of conditions to a recipient. Example conditions that may be used to delineate a supply plan include any one or more of the following: (1) one or more product identifiers, product descriptions, and/or product characteristics (e.g., color, size, unit of sale packaging, unit of sale quantity); (2) a unit price; (3) a discount of unit price based on quantity tiers; (4) a discount percentage or value; (5) a delivery method (e.g., ground shipment, air shipment, expedited, drop shipment); (6) a shipment date; (7) an arrival date; (8) a minimum quality level. These are provided for illustration only. A supply plan may be instantiated as a purchase order, a supply contract that identifies periodic shipment volumes, a combination thereof, or other agreement by which a supplier supplies products to another entity using pre-arranged terms.

In one or more embodiments, a deviation from a supply plan may correspond to any condition delineated in a supply plan that is not or will not be met during a shipment. Example deviations include a decrease in quality level, a difference in product number or product characteristics from those previously agreed to, the use of a substitute product (i.e., a different part number or SKU) different from the product agreed to in the supply plan, a change in price or applied discount, a delayed or improperly accelerated delivery, among others.

In one or more embodiments, a remedial action is any action taken by a supplier in response to deviating from a supply plan. Example remedial actions include, but are not limited to, providing a discount, revising a sale price, providing a substitute product when a contracted product is not available, accelerating shipment of a product, providing a replacement shipment of products failing to meet a quality level or product characteristics, and combinations thereof.

In one or more embodiments, an attribute associated with a supply plan deviation refers to a type of deviation. Examples of deviation types include, but are not limited to, a change in: a quantity of product to be supplied; a price of a product; a delivery time; a delivery location; a volume discount rate; an inadequate quality level; and incorrect product. Another attribute includes a frequency of a deviation associated with one or more of a product and a supplier, and a duration of a deviation. More specific examples of attributes (or alternatively or additionally, data used to quantify attributes) include timeliness of delivering products and/or services, price differences between purchase order (PO) price and invoice price, quality of products and/or services provided by the supplier, and fulfillment rate. Price differences between PO and invoice prices may take into account a monetary difference between PO and invoice prices, and/or a number of differences between PO and invoice prices. Product and/or service quality may take into account a number of returns requested, and/or a number of recalls made. A fulfillment rate may take into account a number of backorders, a number of partial fills, and/or a number of canceled items.

In some examples, data related directly to attributes of a supplier itself (alternatively referred to as “external information”) may be considered in addition to, or in substitution of, product supply attributes. Supplier entity attributes include, for example, credentialing factors, and corporate diversity. Credentialing factors may take into account sanctions levied against an entity, data breaches, third-party assessments of bankruptcy risk and credit (such as, FRISK scores, FICO scores, D&B scores, Equifax scores), number of employees employed by the entity, credentials of the employees. Corporate diversity may take into account a percentage of minority ownership and/or employment.

In one or more embodiments, a sentiment level of a supply plan deviation and/or remedial action may be identified. A level of sentiment reflects whether an opinion expressed in the message is positive, negative, or neutral. In some embodiments, the level of sentiment may also indicate a level of severity of a supply plan deviation and/or an acknowledgement of the severity on the part of the supplier causing the deviation. In an embodiment, sentiment analysis may identify a level of responsiveness of a particular message. For example, a notification (e.g., a message via a channel) may be transmitted by a supplier in reply to an initiating message from a purchaser that identifies a supply problem. The system may also use sentiment analysis to determine a level of responsiveness exhibited by a remedial action to a supply plan deviation. In one example, a customer may transmit a message requesting a refund. A supplier may reply with a message providing an apology and the requested refund. The supplier's message would be associated with a high level of responsiveness. Additional and/or alternative attributes of a message may be reflected by a message rating.

In one or more embodiments, a supplier score represents a level of performance and/or excellence of the supplier. A supplier score represents a level at which a supplier has met, meets, and/or will meet terms of an agreed supply plan (e.g., expectations identified in a long term contract or discrete PO). As an example, a supplier score for a supplier may represent a degree to which the supplier delivers high quality products at a low price in a timely manner. As another example, a supplier score may be in proportion to the frequency and severity of supply plan deviations generated by the supplier.

In one or more embodiments, a keyword library includes a set of words, phrases, sentences, and/or variables that may be used to analyze supply plans, supply plan deviations, and remedial actions. Different keyword libraries may be associated with messages of different message attributes. A keyword library may indicate relationships between (a) words and phrases and (b) deviation attributes (and in particular, deviation type and severity). The keyword library may operate in concert and coordination with semantic analysis systems and machine learning systems, as described below.

### 2.2 Supply Notification Analysis System Architecture

FIG. 1 illustrates a system 100 in accordance with one or more embodiments. In some embodiments, the system 100 may determine a severity level of a supply plan deviation based on a type of impact to a supply status of a product caused by the corresponding supply plan deviation. In one or more embodiments, the system 100 may generate supplier scores that may be absolute values, relative values (i.e., scores for a particular supplier normalized relative to other suppliers of the same product(s)), limited to a particular product, and combinations thereof. In some embodiments, the system may also generate an acceptability score for a remedial action proposed in response to a corresponding deviation. The system may include sub-systems that execute machine learning, natural language processing, and/or sentiment analysis techniques.

As illustrated in FIG. 1, system 100 includes clients 102A, 102B, a machine learning (ML) application 104, a data repository 128 and external resources 124A, 124B. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In some examples, the clients 102A, 102B may be a web browser, mobile application, or other software application communicatively coupled to a network. In other examples, a client 102A, 102B may be associated with a human user (such as a system administrator, inventory manager, procurement or supply specialist) or associated with another application, such as a shell or client application. In some examples, a client 102A, 102B is an interface used for communication between systems (e.g., a supplier communication channel, a product management system).

A client may interact with an embodiment of the machine learning application 104 that is instantiated as a cloud service using one or more communication protocols, such as HTTP and/or other communication protocols of the Internet Protocol (IP) suite. In other embodiments, in which ML application 104 may be instantiated as a local system (e.g., via an “on-premises” computer system), the clients 102A, 102B may be a desktop or other standalone application that may access the ML application 104.

The example ML application 104 illustrated in FIG. 1 includes a supplier communication system 106, a product management system 108, a machine learning engine 110, a frontend interface 118, and an action interface 120. In some embodiments, ML application 104 is a cloud service, such as a software-as-a-service (SaaS) or a web service. In other embodiments, the ML application 104 is operated system on a dedicated system (e.g., in a private network, an “on-premises” computer system, a private distributed computer network system).

The supplier communication system 106 of the ML application 104 may facilitate communications with various suppliers as a dedicated supply communications channel and/or as a single interface through which different channels may be operated or analyzed. The supplier communication system 106 may be used to place orders (e.g., POs) with suppliers, monitor notifications and/or messages regarding shipment and/or delivery of products, monitor fulfillment status of periodic shipment associated with long term supply contracts, track order status, and/or track shipment status. The supplier communication system 106 may also receive notifications from suppliers regarding deviations from supply plans.

The supplier communication system 106 may be in communication with other elements of the machine learning application 104. The supplier communication system 106 may, upon receiving a supplier notification or other communication indicating a deviation, process the notification and optionally share the notification with other elements of the machine learning application 104. Other elements of the machine learning application 104 may then apply the techniques described below (e.g., sentiment analysis, trained machine learning model analysis, supply scoring) to analyze a notification, identify a deviation, identify a severity level of a deviation and a corresponding acceptability of a remedial action, score a supplier, among other analytical operations.

In some examples, the product management system 108 may, in communication with the data repository 128, monitor inventory levels, inventory depletion rates, expected re-supply quantities and receipt dates, production and out-going shipment schedules, as well as process both in-coming and out-going purchase orders. In some cases, the product management system 108 may perform many functions associated with an inventory management system, in addition to being in communication with other elements of the machine learning application 104. For example, the product management system 108 may receive queries submitted by a client (e.g., as operated by a supply manager) as to inventory levels and present query results. The product management system 108 may monitor current inventory levels and be used for generic inventory management functions, such as executing quarterly “closings,” and storing customer and supplier profiles (e.g., addresses, financial information, payment histories). The product management system 108 may also request, receive, and store schedules and shipment durations related to requests for products submitted as part of managing the incoming supply of a product and the outgoing deliveries of products. For example, the product management system 108 may track receipt dates, shipment progress, and other timing and quantity aspects used to coordinate incoming and outgoing product orders.

The product management system 108 may, in some embodiments, receive analyses of supplier notifications from the machine learning engine 110 (described below) and use the analysis to estimate supply impacts for associated products. For example, the product management system 108 may receive from the machine learning engine an indication that a particular product will be delivered two weeks after the contracted delivery date. The product management system 108 may then query the data repository system 128 to identify current inventory levels and execute an analysis of historical shipment and/or supply depletion data for the product as a function of time. These can be compared to determine whether the existing inventory of the product is sufficient to meet predicted demand. The product management system may also store outstanding, but unfulfilled, orders for the product and use this as part of its analysis. Once executed, the estimated supply impacts can be passed back to (or shared with) e 111 the machine learning engine 110, as a factor used to identify a severity of the supply plan deviation and/or an acceptability of a remedial action.

The machine learning engine 110 includes training logic 112, communication analysis logic 113, acceptability evaluator logic 114, and supplier scoring logic 116. The machine learning engine 110 may be trained using the training logic 112 to identify associations between deviations from a supply plan and corresponding remedial actions proposed in response to a deviation. For example, the training logic 112 of the ML engine 110 may be trained by analyzing training data sets. These training data sets may include one or more notifications indicating a supply plan deviation, a remedial action that is provided in response to the deviation, and a level of acceptability of the remedial action. The acceptability of the remedial action may be indicated (and detected by NLP) by, for example, communications indicating a level of acceptance (e.g., “that will remedy the problem,” or “that is acceptable,” or “that is not acceptable”) or by a tag applied in a supervised learning model.

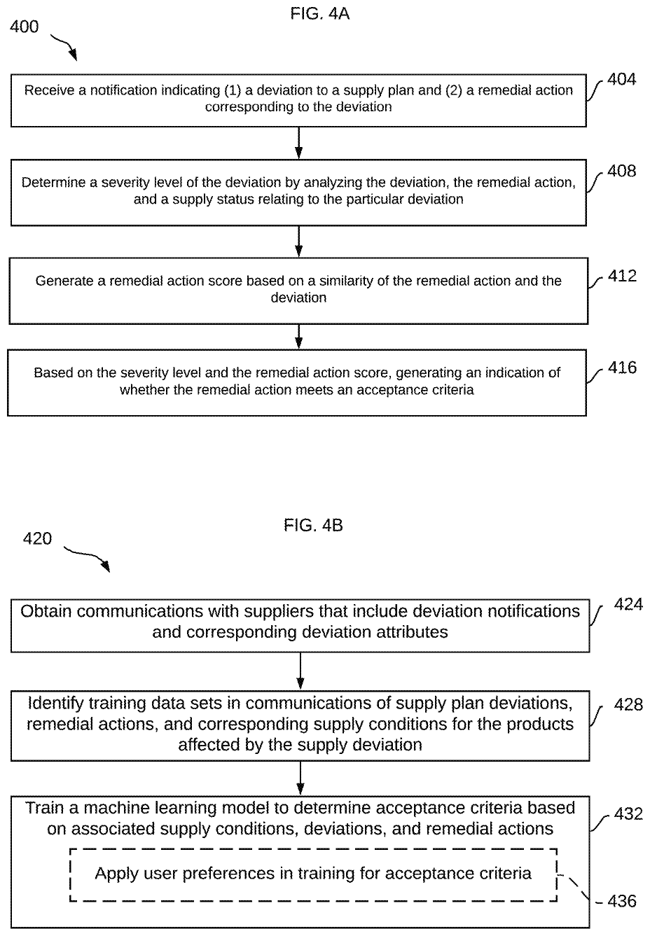

The machine learning model may also be trained to determined acceptance criteria. This training is described below in the context of FIG. 4B. The training may reflect different levels of acceptability for different suppliers, different supplied products, and/or different supply metrics (alternatively referred to as “supply conditions” or “supply status”). The associations between the ordered products and corresponding substitute products, once established by the training logic 112, may be stored in other elements of the system 100, such as the product management system 108 and/or the data repository 128.

The training logic 112 may identify and learn patterns by generating feature vectors of the analyzed communications and/or tags. That is, the ML engine 110 may include logic to identify and extract features from communications and/or tags. These features may include customer identifiers, product identifiers, prices, order dates, scheduled fulfilment dates, deviation and remedial action descriptions, sentiments, content identified by NLP, for example. In some embodiments, using sentiment analysis and keyword analysis, the training logic 112 may also identify a severity level associated with the deviation.

The communication analysis logic 113 may use keywords (such as those stored in the keyword library 136 of the data repository 128), NLP, the trained ML model, sentiment analysis techniques, and combinations thereof, to identify various aspects of communications transmitted to and from the supplier communication system 106. The communication analysis logic 113 may be configured to intercept or scrape one or more communication channels for messages that the system identifies as related to supply plan deviations and remedial actions. Once the communications are identified, the communication analysis logic 113 may identify products that are the subject of the communications (e.g., by identifying pre-determined patterns of characters), suppliers (using keyword matching), and the deviation and corresponding remedial action (using the trained ML model, keyword analysis, NLP).

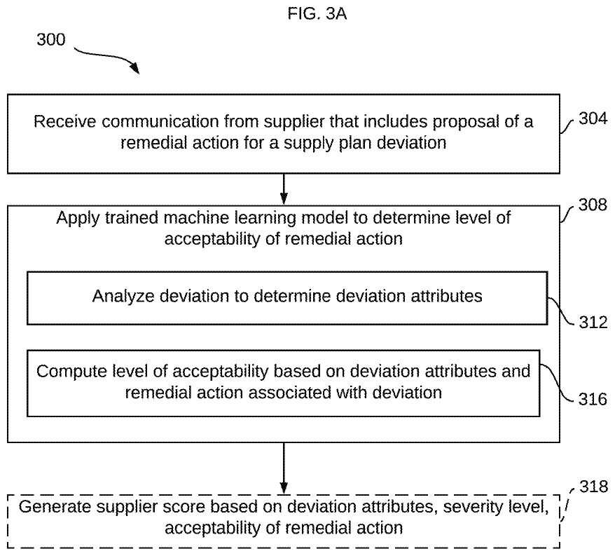

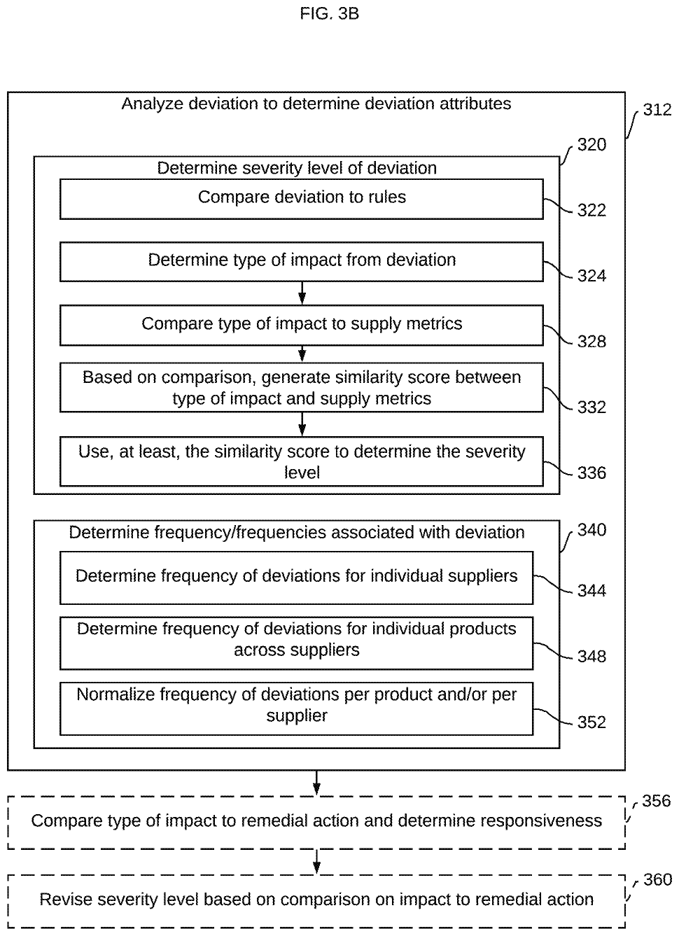

The communication analysis logic 113 may also execute operations described below in the context of one or more of FIGS. 3A, 3B, and 4 to determine other aspects of the deviation and remedial action, such as various attributes.

The acceptability evaluator logic 114 may use information from other elements of the system 100 to evaluate whether a proposed remedial action is acceptable. For example, the acceptability evaluator logic 114 may generate (or use previously generated) feature vectors of deviation descriptions and remedial action descriptions to determine if the remedial action is related to the deviation. If the two are unrelated (e.g., offering a discount in response to a missed delivery date), the remedial action may be unacceptable.

The acceptability evaluator logic 114 may also store rules and/or execute similarity analyses or other types of analyses used to determine a severity level of a deviation. The acceptability evaluator logic 114 may communicate with other elements of system 100 or elements external to the system 100 to determine the impact type and level of a deviation as part of the determination of whether a remedial action is acceptable. For example, the acceptability evaluator logic 114 may communicate with the product management system 108 to identify whether a deviation causes production outages. This information may be compared to the remedial action to determine if the remedial action is acceptable.

The supplier scoring logic 116 may generate a supplier score using deviation attributes, such as severity level, frequency, type, among others. In some cases, the weight of different factors and deviation attributes may be used to emphasize the importance of some aspects over others. In some cases, an entity may permit different sub-entities (e.g., divisions, departments, subsidiaries) to select different weights according to the priorities and preferences of the different sub-entities. In some cases, these weights may be selected on a product by product basis and/or on a sub-entity by sub-entity basis. For example, in some contexts, timely delivery of ordered products is weighted highest and price is weighted less. Deviations that cause late deliveries are thus ranked as highly severe and thus decrease a supplier score substantially whereas a price increase does not affect the deviation severity or supplier score as severely.

In some examples, one or more elements of the machine learning engine 110 may use a machine learning algorithm to identify the patterns described above. A machine learning algorithm is an algorithm that can be iterated to learn a target model f that best maps a set of input variables to an output variable, using a set of training data. A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

In an embodiment, a set of training data includes datasets and associated labels. The datasets are associated with input variables (e.g., target product identifiers, target product descriptions, customer identifiers) for the target model f. The associated labels are associated with the output variable (e.g., substitute product identifiers, substitute product descriptions) of the target model f. The training data may be updated based on, for example, feedback on the accuracy of the current target model f. Updated training data is fed back into the machine learning algorithm, which in turn updates the target model f.

A machine learning algorithm generates a target model f such that the target model f best fits the datasets of training data to the labels of the training data. Additionally or alternatively, a machine learning algorithm generates a target model f such that when the target model f is applied to the datasets of the training data, a maximum number of results determined by the target model f matches the labels of the training data.

The frontend interface 118 manages interactions between ML application 104 and clients 102A, 102B. For example, a client may submit requests to perform various functions and view results through frontend interface 118. In some embodiments, frontend interface 118 is a presentation tier in a multitier application. Frontend interface 118 may process requests received from clients, such as clients 102A, 102B, and translate results from other application tiers into a format that may be understood or processed by the clients. Frontend interface 118 may be configured to render user interface elements and receive input via user interface elements. For example, frontend interface 118 may generate webpages and/or other graphical user interface (GUI) objects. Client applications, such as web browsers, may access and render interactive displays in accordance with protocols of the internet protocol (IP) suite. Additionally or alternatively, frontend interface 118 may provide other types of user interfaces comprising hardware and/or software configured to facilitate communications between a user and the application. Example interfaces include, but are not limited to, GUIs, web interfaces, command line interfaces (CLIs), haptic interfaces, and voice command interfaces. Example user interface elements include, but are not limited to, checkboxes, radio buttons, dropdown lists, list boxes, buttons, toggles, text fields, date and time selectors, command lines, sliders, pages, and forms.

The action interface 120 provides an interface for executing actions using computing resources, such as external resources 124A, 124B. Action interface 120 may include an API, CLI, or other interfaces for invoking functions to execute actions. One or more of these functions may be provided through cloud services or other applications, which may be external to ML application 104. For example, one or more components of system 100 may invoke an API to communicate with suppliers via a communication channel. In another example, one or more components of system 100 may invoke an API to inventory, financial, or production systems that may provide information in response to a query related to a deviation (e.g. a severity level).

In some embodiments, external resources 124A, 124B are network services that are external to ML application 104. Example cloud services may include, but are not limited to, social media platforms, email services, short messaging services, enterprise management systems, verbal communication systems (e.g., internet based voice communications, text chat communications, POTS communications systems) and other cloud applications. Action interface 120 may serve as an API endpoint for invoking a cloud service. For example, action interface 120 may generate outbound requests that conform to protocols ingestible by external resources 124A, 124B. Action interface 120 may process and translate inbound requests to allow for further processing by other components of ML engine 110. Action interface 120 may store, negotiate, and/or otherwise manage authentication information for accessing external resources 124A, 124B. Example authentication information may include, but is not limited to, digital certificates, cryptographic keys, usernames, and passwords. Action interface 120 may include authentication information in the requests to invoke functions provided through external resources 124A, 124B.

In one or more embodiments, the system 100 may include or more data repositories 128. A data repository is any type of storage unit and/or device (e.g., a file system, database, collection of tables, or any other storage mechanism) for storing data. Further, the data repository may include multiple different storage units and/or devices. The multiple different storage units and/or devices may or may not be of the same type or located at the same physical site.

A data repository, such as the data repository 128 shown, may be implemented or may execute on the same computing system as the machine learning application 104. The data repository 128 may be communicatively coupled to the machine learning application 104 via a direct connection or via a network.

The example data repository 128 includes a data partition 132 that stores inventory levels and product locations within a supply system. Storing these data enables the other elements of the machine learning application 104 to identify current inventory levels, historical inventory levels, depletion rates, shipment arrival dates, and various other inventory management functions described above (e.g., in the context of the product management system 108).

The example data repository 128 also includes a data partition that stores the keyword library 136. The keywords of the keyword library 136 may be associated with different suppliers, sentiments, deviations, remedial actions, and deviation attributes (such as severity, type, frequency).

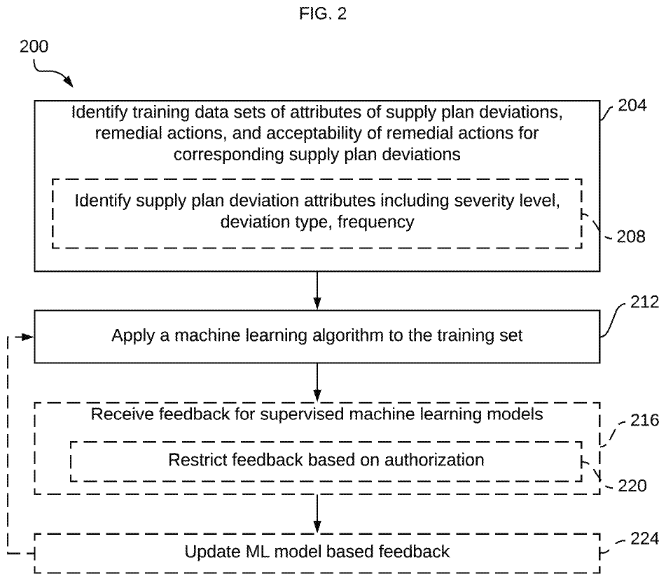

Examples of operations for training the machine learning application 104 are described below with reference to FIG. 2 and FIG. 4B. Examples of operations for using the machine learning application 104 are described below with reference to FIGS. 3A and 3B.

In an embodiment, the system 100, including the machine learning application 104, are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, the term “interface” refers to hardware and/or software configured to facilitate communications between digital devices or a user and the system 100. An interface may render user interface elements and receive input via user interface elements. Examples of interfaces include those indicated above in the context of system 100.

In an embodiment, different components of example interfaces may be specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). In some examples, interfaces may be specified in one or more other languages, such as Java, C, or C++.

Additional embodiments and/or examples relating to computer networks are described below in Section 6, titled “Computer Networks and Cloud Networks.”

### 3. Supply Plan Deviation Analysis Techniques

The following section describes example techniques that may be used to train a machine learning model in preparation for application to the analysis of supply deviation notifications, detection of a severity of a supply deviation, identification of a remedial action and its acceptability in addressing the deviation, supplier scoring, among other aspects. A description of example application techniques follows the description of training techniques.

### 3.1 Machine Learning Engine Training

FIG. 2 illustrates an example set of operations (shown as method 200) for training a machine learning model to analyze deviations from a supply plan and determining acceptability of remedial actions submitted in association with corresponding deviations, in accordance with one or more embodiments. The method 200 may begin by identifying training sets of training data that include sets of corresponding supply plan deviations, remedial actions, and remedial action acceptability. The acceptability of remedial actions in these training sets may be detected using sentiment analysis and/or indicated by tags supplied within the context of a supervised learning model (operation 204).

In some examples, the training data sets may be analyzed using various natural language processing (NLP) techniques and sentiment analysis tools so as to efficiently identify notifications for the training data sets. In other words, NLP may be used to identify related communications (e.g., associated with a particular product number, supplier, and/or particular deviation) within a collection of communications so that related communications may be grouped together in a set. This grouping may improve the precision of the trained machine learning model.

The system may optionally further analyze training sets to identify attributes corresponding to a severity level of the deviation, a deviation type, a frequency, and an acceptability of a remedial action (operation 208). For example, NLP, sentiment analysis, and keyword matching (to a library of keywords associated with sentiments) may be used to identify indications of the severity of a deviation. Communications (whether a notification from a supplier, a response to a notification from an entity, or other communication) that includes terms such as “immediate attention required,” “unacceptable,” “please address soon,” “please check and let us know,” “correct in next shipment,” “rejected,” “repeated error,” and similar phrases all suggest different levels of urgency and severity. Similarly, terms and phrase such as “late,” “delayed,” “missed target” suggest a deviation type related to shipment or receipt times.

The system may also apply the above techniques to determine if additional urgency is communicated to indicate an inability of the purchasing entity to operate as planned. For example, “out of stock,” “missed shipment” and the like can indicate a business interruption caused by the deviation, thereby increasing the severity of the deviation.

A frequency attribute may be determined by searching training data sets for a supplier identifier (whether a name, number, ID, or the like), a product identifier, a contract number, and/or combinations thereof. A frequency attribute may be associated with a product, a supplier, or a contract.

Once the various training materials have been identified, an ML algorithm may be applied to the training data sets (operation 212). The ML algorithm analyzes the training data set to identify data and patterns that indicate supply plan deviations and deviation attributes, remedial actions, and the acceptability of remedial actions, as described above. Types of ML models include but are not limited to linear regression, logistic regression, linear discriminant analysis, classification and regression trees, naïve Bayes, k-nearest neighbors, learning vector quantization, support vector machine, bagging and random forest, boosting, backpropagation, and/or clustering.

In examples of supervised ML algorithms, the system may optionally obtain feedback on the various aspect of the analysis described above (operation 216). For example, the feedback may affirm or revise the severity of a deviation, an acceptability of a remedial action, revise (e.g., add or delete) attributes associated with a deviation, among other aspects. In some examples, the feedback may be restricted to those authorized to provide the feedback, such as supply chain managers, procurement managers, and the like (operation 220). In some cases, those authorized to provide feedback for supervised learning models are executive level or otherwise have experience and authority to make judgments on deviation severity.

Based on association identified by the machine learning model and/or feedback, the ML training set may be updated, thereby improving its analytical accuracy (operation 224). One benefit of using a trained machine learning model in this context is that it may improve accuracy of communication analysis, thereby reducing “false positive” and “false negative” interpretations of communications. That is, the system is less likely to incorrectly identify a communication as reporting a deviation and also less likely to incorrectly fail to identify a communication properly reporting a deviation.

Once updated, the ML model may be further trained by optionally applying it to additional training materials.

### 3.2 Supply Plan Deviation Analysis

FIG. 3A illustrates an example set of operations (shown as method 300) for applying a trained machine learning model to analyze deviations from a supply plan and determine acceptability of remedial actions submitted in associated with corresponding deviations, in accordance with one or more embodiments. The method 300 may begin by receiving a communication from a supplier that includes at least a remedial action (operation 304).

In some embodiments, the communication may be received through a general purpose communication channel, such as a generic email interface. In some embodiments, the communication may be received through a communication channel that is configured to manage supply plan communications. In some examples, the system may be configured to intercept or scrape one or more communication channels for messages that the system identifies or infers as related to supply plan deviations and remedial actions. In some examples, the system may infer one or both of a supply plan deviation and a remedial action in communications sent by an entity to its supplier (e.g., from an entity stating “We noticed this price is too high. Will you correct the PO price?”). Additionally, or alternatively, a communication channel may transmit copies of messages to the system for analysis. Such a communication channel may be in communication with inventory management systems, financial operations systems, purchase order management systems, and the like.

In some examples, the system may identify separate communications that relate to a set of corresponding supply plan deviations and remedial actions by identifying in the communications one or more of a common purchase order number, common part identifier (e.g., part number, part name, part description, SKU), notification date, supplier identifier (name, account number, address). Once the system identifies separate, but related, notifications, the system may execute the analyses described below.

Regardless of the channel through which the communication is received, one or more of the techniques described above may be applied to the communication to determine a level of acceptability of a remedial action (operation 308). As part of determining acceptability of a remedial action (operation 308), the system may also apply these techniques, individually and in their various combinations, to identify a deviation and analyze the deviation to determine attributes associated with the deviation (operation 312). FIG. 3B illustrates various operations within the operation 312, further illustrating various attributes that may be identified and used by the system to analyze deviations.

For example, turning to FIG. 3B, one attribute associated with a deviation that the system may detect is a severity level (operation 320). The system may determine some severity levels based on parameters (e.g., time, cost, part number) of the deviation itself and without referring to any other aspects of the associated supply plan or remedial action. For example, the system may compare a deviation to a set of rules identifying deviations parameter values that indicate a level of severity (operation 322). In some examples, the system may use NLP, keyword analyses, and a trained machine learning model to extract parameter values from communications so that the parameter values may be compared to the rules. For example, the system may identify in a notification that a product will be received one month after the contracted receipt date. Based on rules that associate a lateness of shipment with a severity level, the system may identify this delay as severe. Similar rules may be stored and used by the system that identify unexpected price increases greater than a threshold value as severe (e.g., greater than 5%, greater than 10%). In another example, the system may identify that a product provided by a supplier is not the same part number as the product ordered. This too may be identified as a severe deviation based on the rules.

In other examples, the system may analyze a deviation and/or remedial action notification to determine a type of impact (operation 324). This analysis may also be performed using NLP, machine learning, sentiment analysis, keyword analysis, rules, and combinations thereof. For example, the system may use these techniques to determine that the type of deviation is any one or more of the following: (a) an unexpected increased price; (b) an improper receipt date of a product; (c) an incorrect quality level; (d) an incorrect part number or product; (e) an incorrect quantity. These example deviations are provided as examples and for convenience of explanation. Other types of deviations may also be identified by the system based on the techniques described herein.

Each of the illustrated supply plan deviations may have a different impact (or different impacts) to a receiving entity based on the particulars of the entity. In some examples, the system may store a set of rules or train a machine learning model to associate one or more of these deviations with type of deviation, analogous to the description presented in the context of the operation 320 (operation 324). The degree of severity associated with different types of deviations may be selected on a product by product basis, or a sub-entity by sub-entity basis.

In other examples, a severity of a deviation cannot be conveniently prescribed by rules. For example, a severity level may be a function of an entity's own uses of the received products, its supply chain, operations, materials management processes, inventory status, production rate, and financial situation. These variables and their fluctuations may render fixed rules too imprecise to be useful.

In some example the system may compare the determined impact type to one or more supply metrics as part of a process for determining a severity level (operation 328). Example supply metrics used to characterize a supply status may include, but are not limited to, the various supply chain conditions indicated above, such as production rate, inventory level, revenue rate, outstanding orders, cash on hand, among others.

The system may, for example, use NLP and machine learning techniques to vectorize a communication reporting a deviation to determine an impact type (operation 332). The system may then execute a query to determine various supply metrics that are related to the deviation (e.g., identifying a part number in the deviation notification and searching an product management system for Bills of Materials that include that part number). The system may then execute a similarity analysis (e.g., cosine similarity) to compare the deviation impact type to the various supply metrics (operation 332). This comparison may determine whether a deviation is similar to a supply metric related to the deviation. For example, if a deviation indicates that a delivery will be delayed by a day, this may be identified as a severe deviation if the current inventory within the receiving entity is less than a production rate multiplied by the delay duration (in this case, one day). In other words, production using the delayed component will cease because of the delay. This rates as a severe deviation even though the delay is relatively short. The severity may increase further if there are outstanding orders for the product that has ceased production because of the delay. Conversely, the one-day delay may not be severe if the inventory level within the entity can accommodate multiple days of production, thereby avoiding production disruptions because of the delay.

The similarity score may be generated between the deviation and one or more supply metrics (e.g., inventory level, production rate, revenue rate associated with a product, outstanding orders). In some examples separate scores may be generated between the deviation and one or more supply metrics and the resulting similarity scores added together.

The similarity score may be used to determine the severity level (operation 336). The higher the score, the more similar the deviation is to one or more supply metrics. The score may indicate the number of supply metrics having a similarity score above a threshold, thereby indicating a broader impact of the deviation. A higher score may indicate a high similarity with one supply metric, which may itself indicate a severe deviation. Regardless, one or more thresholds may be established to progressively delineate higher severity levels of deviations.

In addition to type and severity level, some embodiments may include one or more deviation frequencies as an attribute (operation 340). For example, deviation frequencies may be generated in some examples for individual suppliers (operation 344). This embodiment may include deviations across all products supplied by a supplier, thereby capturing the overall performance of the supplier. The system may identify a supplier identifier (e.g., an email address, an account number, a unique identifier) and then use the supplier identifier to search for deviations associated with the supplier identifier within the various data storage systems and communication channels.

In another example, the system may generate a frequency of deviations for an individual product across multiple suppliers providing the product (operation 348). The system may identify a part identifier of interest and then use the part identifier to search for deviations associated with the part number within the various data storage systems and communication channels. A Pareto chart (or similar evaluation tool) may be generated to conveniently compare the performance of different suppliers to one another.

In some examples, either of the preceding deviation frequencies may be normalized to enable a pro rata comparison between parts and/or suppliers (operation 352). For example, a frequency of deviations can be divided by a total number of units received (for a single supplier or across suppliers), by a revenue level, or any other convenient normalizing factor that improves the basis of comparison.

Deviation frequency may be combined with one or both of a deviation type and a severity level in the analysis. For example, deviations having a high severity level (e.g., above a corresponding threshold) but occurring infrequently may be deemed severe and/or decrease a supplier score. Deviations having a low severity level but occurring frequently may cause the system to generate a similar severity level to rare, but severe deviations. As with other aspects described above, frequency thresholds may be established generically or may be adjusted as a function of supply metrics. For example, a critical part that is essential to continue production of multiple products, a component for revenue generating products, or a part that historically has experienced supply plan deviations may have low deviation frequency thresholds (i.e., triggering action at low occurrence frequencies) whereas a less critical part may have a high threshold for indicating a severe deviation.

In some examples, the operations associated with operation 312 optionally include comparing the type of impact determined in operation 324 to the remedial action received in the notification of operation 304 to determine the degree of responsiveness of the remedial action to the deviation (operation 356). The system can perform this comparison using the techniques described above, which include NLP, sentiment analysis, machine learning, keyword analysis, and similarity scoring. In this comparison, the system may identify similarities between the remedial action and the impact type to determine if the remedial action proposed by the supplier is responsive to or related to the deviation. For example, if a remedial action in a notification is a discount and the system-identified deviation type is a supply disruption, a similarity analysis would indicate that the remedial action does not actually reduce the impact of the deviation. In contrast, a remedial action in a notification that proposes providing a substitute product in response to a supply disruption deviation is responsive to the deviation.

Based on the comparison and the determined responsiveness, the system may generate a resolution value based on the degree of similarity (e.g., proportional to a cosign similarity value) for the remedial action. The system may use the resolution value to revise the severity level of the deviation (operation 360). In other words, if the remedial action is responsive to the deviation, the system may reduce the severity level of the deviation. If the remedial action is not responsive to the deviation, the system may maintain or increase the severity level of the deviation.

Returning to FIG. 3A and the method 300, upon determining various deviation attributes, the system may compute a level of acceptability of the remedial action based on the deviation attributes and the associated remedial action (operation 316). Much like aspects described above, acceptability may be based on one or more similarity scores determined between deviation attributes and the corresponding remedial action. Similarities may be determined based on one or more of a keyword analysis, NLP analysis, trained machine learning analysis, among others. The more similar the attributes and remedial action, the higher the acceptability of the remedial action. In other words, the more likely the remedial action is to reduce an impact caused by the deviation, the higher the acceptability score.

In some embodiments, the system may use the preceding analyses to optionally generate a supplier score based on one or more of deviation attributes, severity level, remedial action acceptability (operation 318). For example, the supplier score may be generated in proportion to a frequency of deviations, an absolute number of deviations normalized according to a number of units purchases, a number of purchase orders issued, an expense amount, a sum of products of a deviation multiplied by a corresponding severity. Other techniques may be used to generate supplier scores. Normalized scores in particular may be used to compare different supplier performances to one another. This in turn can be used to guide supplier management strategy.

For example, the system may use the various elements described above (e.g., deviation type, deviation severity, deviation frequency (or frequencies), appropriateness of remedial action) to generate a numerical score for individual suppliers. These scores may be normalized. Each normalized numerical score may be referred to as an “normalized supplier score.” In some examples, elements used to generate the numerical score may be weighted so that some elements contribute more to the score than other elements

As an example, there may be a high percentage of a price difference between a PO price and an invoice price (e.g., more than 10%, more than 25%). The customer may transmit a message to the supplier to identify the problem. The supplier may promptly respond with a message including an apology and a correction to the problem. While the deviation itself may be severe, the appropriateness of the remedial action and the low revised severity (given that the remedial action completely resolved the deviation) may have high weights in the scoring operation. While the presence of any deviation may tend to lower a supplier score, the more heavily weighted elements reduce the impact of the deviation to the score.

In some embodiments, a supplier score may be revised if the communicated deviation did not actually occur. For example, the remedial action may resolve the deviation so that a price is adjusted before payment is made, the inventory is not depleted, production is not halted as initially indicated by the deviation analysis. In these cases, any decrease in the supplier score may be reversed.

In an embodiment, the supplier score may be presented on a user interface. The supplier score may be presented as a numerical value. Additionally, or alternatively, the supplier score may be presented as a graphic. The supplier score may be presented, for example, using a bar. The supplier score may be represented by a level at which the bar is filled in.

In some examples, the supplier score may be presented as part of a supplier profile on a user interface. A user may gain a big picture understanding of the supplier based on the supplier profile. In some examples, the system may present a supplier score as part of a candidate listing of suppliers that are available to provide a product and/or service. A user may thereby compare the suppliers and select a most appropriate supplier for purchasing the product and/or service. In some examples, the system may present the supplier score as a tag associated with any appearance of the supplier's name on a user interface. The tag may be presented beneath the supplier's name, or the tag may be presented only when there is a mouseover the supplier's name. A user may thereby gain a quick glance at a performance level associated with the supplier within any user interface with which the user is interacting (such as an email application user interface, a web browser, a word document).

### 4. Determining Acceptability of Remedial Actions

FIG. 4A illustrates example operations of an example method 400 by which a remedial action may be determined. In one example, the method 400 may begin by receiving, from a supplier, a notification indicating (1) a particular deviation from a corresponding particular supply plan and (2) a particular remedial action corresponding to the particular deviation (operation 404). The operation 404 is analogous to similar operations described above.

The system may determine a severity level of the deviation by analyzing the deviation in the context of both the remedial action and a supply status associated with the product(s) indicated in the deviation (operation 408). As described above in the context of FIG. 3B, a severity level may be determined using rules and using machine learning techniques that determine an impact of a deviation to, for example, revenue, production rates, customer shipments, costs, and other similar downstream effects resulting from a deviation. In particular, the operation 408 determines a severity level in the context of a supply status of the product associated with a deviation. Supply status metrics are also described above in the context of FIG. 3B.

The system may then generate a remedial action score based on a similarity of the remedial action to the deviation (operation 412). As described above, the system may accomplish this by generating feature vectors for the deviation and the remedial action and performing a similarity analysis between the vectors. The more similar the remedial action is to the deviation, the more likely the remedial action is to address the deviation and therefore the higher the remedial action score. For example, a similarity score will be higher if the deviation and the remedial action both refer to the same part numbers, thereby suggesting that the remedial action addresses the same component affected by the deviation. Similarities between quantities and deviation/remedial action type (e.g., financial, quality, delivery date) will also increase the similarity score and therefore the remedial action score.

The system then generates an indication of whether the remedial action meets an acceptance criteria based on the severity level of the deviation and the remedial action score (operation 416). For example, various thresholds may be established that progressively indicate an acceptability of a remedial action score as a function of deviation severity. For example, for deviations that have a high level of severity, an acceptability threshold for a remedial action may be based on a similarity of greater than 0.8 or 0.9 (out of 1) between the remedial action and the deviation. This establishes criteria that require an acceptable remedial action to directly address, and reduce the effects of, a severe deviation. Less severe deviations may be associated with lower acceptability thresholds, thereby designating less similar remedial actions as acceptable.

In a variation of (and/or a complement to) the training techniques described above in the context of FIG. 2, FIG. 4B illustrates example operations of a method 420 by which a machine learning model may be trained to determine an acceptance criteria of a remedial action. The system may apply many of the same techniques described above. This technique may applied to the model used in the method 400, in some embodiments.

For example, the system may obtain (or be provided) communications with suppliers (operation 424). These communications may include a deviation notification (or other type of communication identifying a deviation) and corresponding deviation attributes. The techniques for identifying deviation attributes described above in the context of FIG. 3B may be applied to the operation 424.

The system may then identify training sets within the communications, where individual training sets include communications of corresponding supply plan deviations and remedial actions, and an indication of an adequacy of the remedial action (operation 428). The training set may be associated with supply conditions that relate to the product(s) associated with the remedial action and deviation (operation 428). The supply conditions may be provided to the learning model or the system itself may identify this information by identifying a part number or product reference within the communications and querying other elements of the system (e.g., via the supplier communication system 106 and/or the product management system 108 shown in FIG. 1) to obtain the information.

In some examples the system itself may determine an acceptability of the remedial action in light of the supply conditions. For example, the system may determine whether a delayed shipment will lead to an out of stock condition for a product and further identify the inadequacy of a financial discount or adequacy of a substitute product being supplied. For example, as described above, the system (e.g., using the acceptability evaluator logic 114) may generate vectors representing the remedial action and corresponding supply conditions, and generate a similarity score using these vectors. The system may then use thresholds to establish acceptance criteria of a remedial action. Similarity scores above a threshold may be used to indicate that a supply condition and a remedial action are similar. This in turn may indicate that a remedial action addresses supply conditions related to the deviation and thereby is likely to meet acceptability criteria.

The system may also analyze various combinations of supply conditions associated with a product and compare them, using a similarity analysis, to a remedial plan. The system may use this type of combinatorial analysis to generate acceptance criteria for a remedial plan that incorporates multiple factors associated with a product. For example, the system may examine an inventory level of a product and a consumption rate of the inventory and extrapolate these data to determine whether or not a delayed shipment is likely to have an impact on production. In another example, the system may identify a substitute product number in a remedial action and search production records to identify whether the substitute product may be used in production (e.g., search a database identifying substitute products permitted for use in production e.g., via a “Bill of Materials” database.)

In other examples, an acceptability of the remedial action in light of the supply conditions is determined by a user-supplied tag or similar supervised training technique. The system may store tags in connection with various supply conditions in light of the associated supply plan deviation and remedial action. These tags may be used to indicate one or more acceptability criteria for a remedial action. The system-based and user-based techniques may also be used in combination with one another.

The system may use one or more of the tags and/or similarity scores to train a machine learning model to determine acceptance criteria based on the supply conditions, supply plan deviation, and remedial actions (operation 432).

In some examples, acceptability is optionally further determined based on user preferences (operation 436). For example, some organizations may require constant supplies of some materials. In this case, financially based remedial actions are unlikely to match acceptance criteria, but the on-time delivery of approved substitute products are likely to match acceptance criteria. For other users, the reverse may be reflected in user preference.

### 5. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

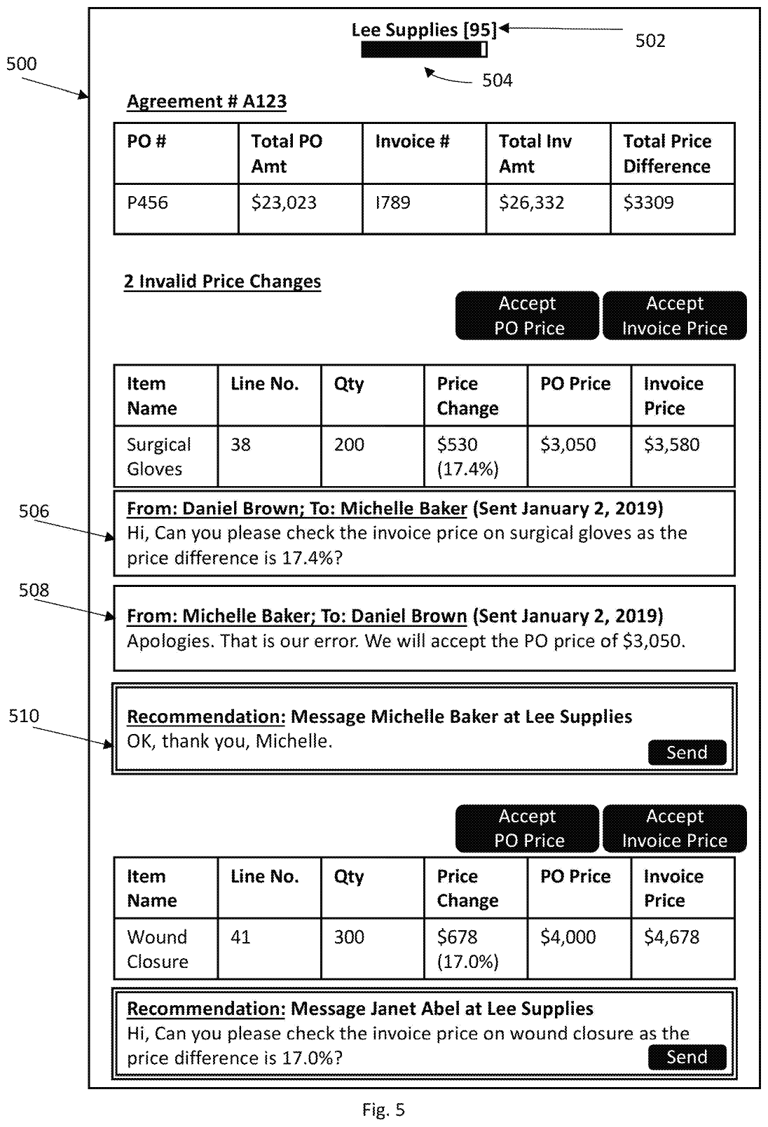

FIG. 5 illustrates an example user interface 500 for presenting a supplier score and communications indicating a deviation and remedial action, in accordance with one or more embodiments.

As illustrated, user interface 500 displays a supplier profile of a supplier, Lee Supplies. User interface 500 presents numerical supplier score 502 and graphical supplier score 504 for Lee Supplies. As indicated, numerical supplier score 502 for Lee Supplies is “95.” Meanwhile, 95% of the bar illustrated as graphical supplier score 504 is filled in to represent the “95” numerical supplier score 502.

User interface 500 presents information about a particular agreement with Lee Supplies, Agreement #A123. User interface 500 indicates that, under the agreement, PO #P456 matches Invoice #1789. User interface 500 presents information regarding price changes between the PO and the invoice. User interface 500 also shows communications exchanged with Lee Supplies regarding the price changes.

One price change involves surgical gloves. In this example, a message 506 is transmitted to Lee Supplies to identify the problem. In this example, the message 506 from the entity ordering surgical gloves from supplier Lee Supplies may be used by the system to identify the deviation as an improper price change for the gloves. In some examples, the message 508 transmitted from Lee Supplies confirms the deviation and proposes a remedial action (i.e., a price reduction). The system may analyze these messages, coordinated via one or more of the purchase order (PO) number, the invoice number, the agreement number, and the supplier name, to identify the deviation and remedial action, as described above.

The system may also analyze these communications to generate and/or update the supplier score 502, 504. The system may generate and/or update the supplier score 502, 504 based on the deviation severity and the acceptability of the remedial action, which directly addresses the deviation (i.e., a price decrease to correct an incorrect price.) In addition, the prompt response to the deviation communication and prompt proposal of an acceptable remedial action may also contribute to the supplier score. In one example, the responsiveness and acceptability of the remedial action may even increase the supplier score 502, 504.

In some examples, the system may even generate a recommendation 510 for content to be included in a message replying to message 508.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

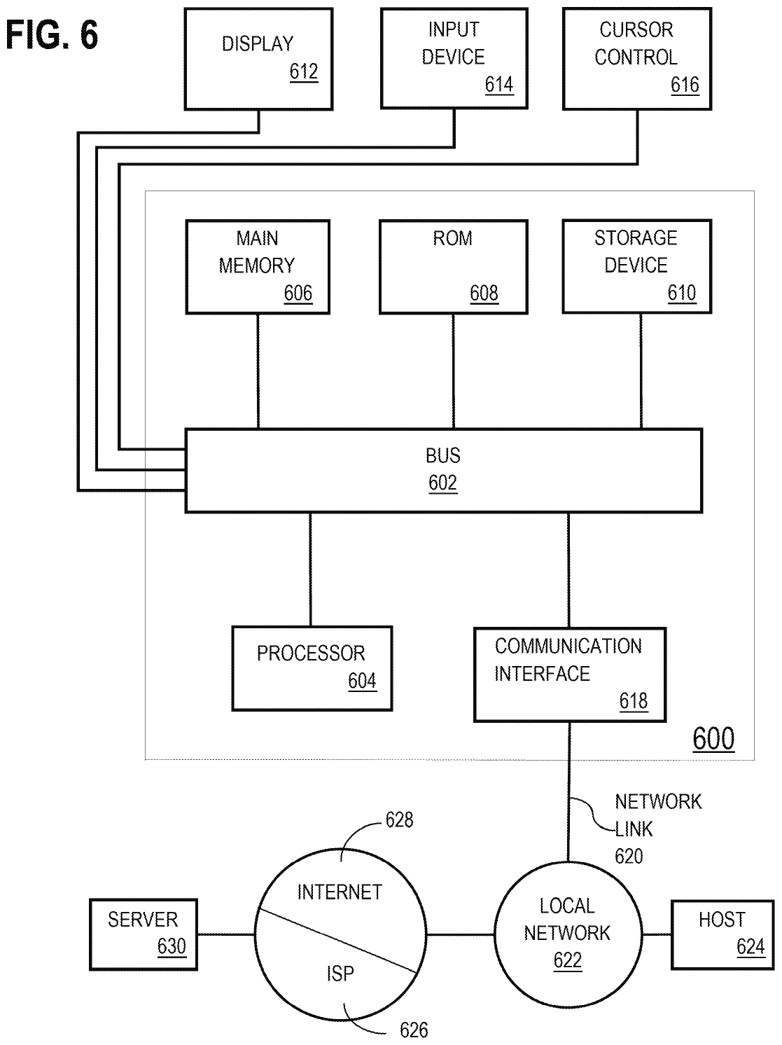

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 8. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory machine-readable media storing instructions which, when executed by one or more processors, cause:
training a machine learning model to compute a level of acceptability of a remedial action corresponding respectively to a supply plan deviation, the training comprising:
obtaining training data sets, each training data set of historical data comprising:
attributes of a particular supply plan deviation by a supplier;
a particular remedial action agreed to or provided by the supplier for the particular supply plan deviation;
a particular level of acceptability of the particular remedial action for the particular supply plan deviation;
training the machine learning model based on the training data sets;
receiving a communication from a supplier comprising a first remedial action for a first deviation to a first supply plan;
applying the machine learning model to compute a first level of acceptability of the first remedial action for the first deviation to the first supply plan, the applying comprising:
analyzing the first deviation to determine a first set of attributes associated with the first deviation; and
computing a first level of acceptability based on the first remedial action and the first set of attributes associated with the first deviation.

2. The medium of claim 1, further comprising generating a supplier score for the supplier, the supplier score based on at least the first set of attributes and the first level of acceptability.

3. The medium of claim 1, wherein computing the first level of acceptability based on the first remedial action and the first set of attributes associated with the first deviation comprises:
computing a severity level of the first deviation based on the first set of attributes associated with first deviation; and
using the severity level with the first remedial action to compute the first level of acceptability.

4. The medium of claim 3, further comprising:
analyzing the first remedial action to determine a resolution value for the first deviation; and
based on the resolution value, changing a first value of the severity level of the first deviation to a second value of the severity level.

5. The medium of claim 3, wherein determining the severity level of the first deviation comprises:
analyzing the communication to determine a type of impact;
comparing the determined type of impact to a set of supply metrics;
generating a similarity score between the type of impact and the set of supply metrics; and
using the set of supply metrics having a value of the similarity score above a threshold to determine the severity level of the first deviation.

6. The medium of claim 5, wherein:
the attributes used to determine the severity level include one or more of a frequency of total deviations, frequencies of a set of deviations sharing one or more attributes, and the type of impact.

7. The medium of claim 5, wherein the type of impact includes one or more of a delayed shipment and a change to a price.

8. The medium of claim 5, further comprising:
comparing the type of impact to the corresponding first remedial action; and
determining whether the first remedial action resolves the type of impact.

9. The medium of claim 5, wherein comparing the determined type of impact to the set of supply metrics further comprises:
identifying a product reference in the communication, the product reference used to identify a supply status of a product associated with the product reference;
comparing the type of impact to the supply status of the product; and
based on the comparison, determining whether the supply status is changed by the first deviation in the communication.

10. The medium of claim 3, wherein a frequency used to determine the severity level is normalized using other deviations sharing the same attributes from other suppliers different from the supplier.

11. The medium of claim 1, wherein training the machine learning model further comprises:
providing classifications of the supply plan deviations to the machine learning model, the classifications identifying:
attributes for the supply plan deviations; and
severity levels associated with the attributes for the corresponding supply plan deviations.

12. The medium of claim 1, wherein:
computing the first level of acceptability based on the first remedial action and the first set of attributes associated with the first deviation comprises:
computing a severity level of the first deviation based on the first set of attributes associated with first deviation;
using the severity level with the first remedial action to compute the first level of acceptability;
analyzing the first remedial action to determine a resolution value for the first deviation; and
based on the resolution value, changing a first value of the severity level of the first deviation to a second value of the severity level;
the operations further comprising:
training the machine learning model by providing classifications of the supply plan deviations to the machine learning model, the classifications identifying attributes for the supply plan deviations and severity levels associated with the attributes for the corresponding supply plan deviations;
generating a supplier score for the supplier, the supplier score based on at least the first set of attributes and the first level of acceptability
determining the severity level of the first deviation by analyzing the communication to determine a type of impact, comparing the determined type of impact to a set of supply metrics, generating a similarity score between the type of impact and the set of supply metrics, and using the set of supply metrics having a value of the similarity score above a threshold to determine the severity level of the first deviation;
comparing the type of impact to the corresponding first remedial action, determining whether the first remedial action resolves the type of impact;
wherein, the attributes used to determine the severity level include one or more of a frequency of total deviations, frequencies of a set of deviations sharing one or more attributes, normalized frequencies, and the type of impact and the type of impact includes one or more of a delayed shipment and a change to a price;
identifying a product reference in the communication, the product reference used to identify a supply status of a product associated with the product reference; and
comparing the type of impact to the supply status of the product; and
based on the comparison, determining whether the supply status is changed by the first deviation in the communication.

13. One or more non-transitory machine-readable media storing instructions which, when executed by one or more processors, cause:
receiving, from a supplier, a notification indicating (1) a particular deviation from a corresponding particular supply plan and (2) a particular remedial action corresponding to the particular deviation;
determining a severity level of the particular deviation by analyzing the particular deviation, the particular remedial action, and a supply status relating to the particular deviation;
generating a remedial action score based on a similarity of the particular remedial action and the particular deviations; and
based on the severity level and the remedial action score, generating an indication of whether the particular remedial action meets an acceptance criteria.

14. The media of claim 13, wherein generating the indication of whether the particular remedial action meets an acceptance criteria comprises applying a trained machine learning model to the notification to analyze the particular deviation and the particular remedial action to determine the severity level and the acceptance criteria.

15. The media of claim 14, further comprising training the machine learning model, the training comprising:
obtaining communications between an entity and a plurality of suppliers comprising notifications of deviations from corresponding supply plans, the deviations comprising one or more attributes;
identifying training data sets in the communications, the training data sets comprising a deviation, a remedial action corresponding to the deviation, and supply status associated with the corresponding supply plans; and
training the machine learning model to determine acceptance criteria based on the associated supply status, deviations, and remedial actions.

16. The media of claim 15, wherein the training comprises receiving user preferences from a supply chain executive regarding the acceptance criteria of the remedial actions for a set of supply status.

17. A method comprising:
training a machine learning model to compute a level of acceptability of a remedial action corresponding respectively to a supply plan deviation, the training comprising:
obtaining training data sets, each training data set of historical data comprising:
attributes of a particular supply plan deviation by a supplier;
a particular remedial action agreed to or provided by the supplier for the particular supply plan deviation;
a particular level of acceptability of the particular remedial action for the particular supply plan deviation;
training the machine learning model based on the training data sets;
receiving a communication from a supplier comprising a first remedial action for a first deviation to a first supply plan;
applying the machine learning model to compute a first level of acceptability of the first remedial action for the first deviation to the first supply plan, the applying comprising:
analyzing the first deviation to determine a first set of attributes associated with the first deviation; and
computing a first level of acceptability based on the first remedial action and the first set of attributes associated with the first deviation.

18. The method of claim 17, wherein computing the first level of acceptability based on the first remedial action and the first set of attributes associated with the first deviation comprises:
computing a severity level of the first deviation based on the first set of attributes associated with first deviation; and
using the severity level with the first remedial action to compute the first level of acceptability.

19. The method of claim 18, further comprising:
analyzing the first remedial action to determine a resolution value for the first deviation; and
based on the resolution value, changing a first value of the severity level of the first deviation to a second value of the severity level.

20. The method of claim 17, wherein:
computing the first level of acceptability based on the first remedial action and the first set of attributes associated with the first deviation comprises:
computing a severity level of the first deviation based on the first set of attributes associated with first deviation;
using the severity level with the first remedial action to compute the first level of acceptability;
analyzing the first remedial action to determine a resolution value for the first deviation; and
based on the resolution value, changing a first value of the severity level of the first deviation to a second value of the severity level;
the operations further comprising:
training the machine learning model by providing classifications of the supply plan deviations to the machine learning model, the classifications identifying attributes for the supply plan deviations and severity levels associated with the attributes for the corresponding supply plan deviations;
generating a supplier score for the supplier, the supplier score based on at least the first set of attributes and the first level of acceptability
determining the severity level of the first deviation by analyzing the communication to determine a type of impact, comparing the determined type of impact to a set of supply metrics, generating a similarity score between the type of impact and the set of supply metrics, and using the set of supply metrics having a value of the similarity score above a threshold to determine the severity level of the first deviation;
comparing the type of impact to the corresponding remedial action;
determining whether the remedial action resolves the type of impact;
wherein, the attributes used to determine the severity level include one or more of a frequency of total deviations, frequencies of a set of deviations sharing one or more attributes, normalized frequencies, and the type of impact and the type of impact includes one or more of a delayed shipment and a change to a price;
identifying a product reference in the communication, the product reference used to identify a supply status of a product associated with the product reference; and
comparing the type of impact to the supply status of the product; and
based on the comparison, determining whether the supply status is changed by the first deviation in the communication.
